(19) United States
(12) Patent Application Publication
(10) Pub. No.: US 2012/0018283 A1
(43) Pub. Date: Jan. 26, 2012

(54) EASY CLEAN CONVEYOR FOR FOOD PRODUCTS

(76) Inventors: Timothy Dallner, Sebringville (CA); Brian Coe, Stratford (CA); Brian Taylor, Gads Hill (CA); Peter Stein, Kitchener (CA)

(21) Appl. No.: 13/187,909

(22) Filed: Jul. 21, 2011

Related U.S. Application Data
(60) Provisional application No. 61/366,800, filed on Jul. 22, 2010.

(51) Int. Cl. B65G 21/00

(52) U.S. Cl. 198/804

(57) ABSTRACT

A conveyor comprises at least one endless conveyor belt extending longitudinally for conveying objects from an inlet end to an outlet end, and a frame extending longitudinally along the conveyor belt and having a cross-section that partially encloses the conveyor belt. The frame includes opposed side frames having longitudinal side openings therein for providing access to the conveyor belt. The conveyor further comprises removable belt guards configured to cover the longitudinal side openings, and belt guard guides located adjacent to the longitudinal side openings. Each belt guard guide is shaped to provide a guideway for slidably receiving the belt guards.

### RELATED

This application claims the benefit of U.S. Provisional Patent Application No. 61/366,800 filed Jul. 22, 2010 and entitled “EASY CLEAN CONVEYOR FOR FOOD PRODUCTS”, the entire contents of which are hereby incorporated by reference herein for all purposes.

### TECHNICAL FIELD

The invention relates to conveyors for food products, and in particular to conveyors that can be easily cleaned.

### BACKGROUND

Conveyor systems are used to transport food products between various locations in a food production facility using a conveyor belt. The surfaces of these conveyor systems can become contaminated with microorganisms, which presents a serious health risk. For example, Listeria has recently become a serious concern for meat processors in addition to other microorganisms such as Escherichia coli, Salmonella choleraesuis, Staphylococcus, Aspergillus, Streptococcus, Klebsiella, and Clostridium. When food is contaminated with one or more of these microorganisms, the food must be destroyed to protect the public health and prevent serious health risks that would otherwise result from ingestion. Unfortunately, destroying food represents a significant cost to food producers and it is preferable to utilize other preventative measures.

Some food producers attempt to reduce the likelihood of contamination by cleaning conveyor systems on a regular basis. Unfortunately, conveyor systems have many parts and it can be difficult to thoroughly clean some surfaces of the conveyor. In particular, some conveyor systems have frames that often block some areas of the conveyor (such as the conveyor belt) and can make cleaning difficult.

One method of overcoming this problem is to utilize frames with openings therein. The openings provide access points for cleaning the conveyor. However, these openings must be securely covered during operation to comply with safety legislation and regulations governing the food industry. Unfortunately, these covers can be heavy, which makes them difficult and time consuming to remove, and makes cleaning more difficult.

Some covers are attached to the frame using hinges, which makes it easier to open the cover when cleaning the conveyor. However, the hinges have small crevices and gaps that are difficult to clean and tend to collect bacteria, which is undesirable.

Accordingly, there is a need for new or improved conveyors that can be easily cleaned.

### SUMMARY OF THE INVENTION

According to one aspect of the present invention there is provided a conveyor for use in the food industry. The conveyor comprises a frame extending longitudinally between an inlet end and an outlet end. The frame has two side frames. Each side frame has an upper member and a lower member spaced apart so as to define a longitudinal opening therebetween extending along the frame. The upper and lower members of each side frame have opposing longitudinal channels therein. The conveyor also comprises an endless conveyor belt extending longitudinally along the frame for conveying food products from the inlet end of the frame to the outlet end. The conveyor belt is disposed between the longitudinal openings within the side frames. The conveyor also comprises at least one belt guard configured to slide into the opposing longitudinal channels along each of the side frames so as to partially cover the conveyor belt, and at least one fastener for removably securing the at least one belt guard to the frame.

In some embodiments, the conveyor may comprise a plurality of rigid upper side guards removably attached to the side frames and extending upward from the frame above the conveyor belt. The upper side guards have a pair of opposing spaced apart longitudinal slots disposed above the conveyor belt. The conveyor may also comprise an upper belt guard configured to slide between the opposing longitudinal slots of the upper side guards.

Furthermore, the frame may comprise cross-members extending between the side frames. Furthermore, the conveyor may comprise at least one longitudinal runner having a lower surface with notches thereon shaped to interlock with corresponding notches on the cross-members of the frame such that the runner is removably mounted to the frame for supporting a portion of the conveyor belt.

The conveyor may further comprise upper belt guides mounted to interior faces of the upper side guides for positioning the conveyor belt between the upper belt guides and the longitudinal runners.

In some embodiments, the conveyor may comprise a pair of rigid lower side guards removably attached to the side frames and extending downward from the frame below the conveyor belt. The lower side guards have a pair of opposing spaced apart longitudinal ledges disposed below the conveyor belt. The conveyor may also comprise a lower belt guard configured to slide on top of the opposing longitudinal ledges of the lower side guards.

The conveyor may further comprise lower belt guides mounted to the lower side guards for supporting the conveyor belt.

According to another aspect of the present invention there is provided a conveyor comprising at least one endless conveyor belt extending longitudinally for conveying objects from an inlet end to an outlet end, and a frame extending longitudinally along the conveyor belt and having a cross-section that partially encloses the conveyor belt. The frame includes opposed first and second side frames. Each side frame has a longitudinal side opening extending longitudinally along the side frame for providing access to the conveyor belt. The conveyor further comprises first and second removable belt guards. Each belt guard is configured to at least partially cover one of the longitudinal side openings. The conveyor further comprises first and second belt guard guides. Each belt guard guide is located adjacent to one of the longitudinal side openings and is shaped to provide a guideway for slidably receiving one of the belt guards.

The conveyor may further comprise fasteners for removably securing the belt guards to the frame.

Each side frame may include opposed upper and lower members spaced apart so as to define the longitudinal side opening therebetween. Each belt guard guide may comprise a longitudinally extending upper rail spaced laterally outwardly and downwardly from the upper member, and a longitudinally extending lower rail spaced laterally outwardly and upwardly from the lower member.

The frame may include opposed first and second rigid upper side guards. Each upper side guard may extend upwardly from one of the side frames above the conveyor belt so as to define a longitudinal top opening extending between the upper side guards. Furthermore, the conveyor may comprise an upper belt guard for at least partially covering the longitudinal top opening, and an upper belt guard guide located adjacent to the longitudinal top opening. The upper belt guard guide is shaped to provide a guideway for slidably receiving the upper belt guard.

The upper side guards may be removably mounted to the side frames. For example, each side frame may include a plurality of upwardly extending pins, and each upper side guard may include a base portion with key slots shaped to receive the pins so as to removably mount the upper side guard to the side frame.

The conveyor may further comprise at least one longitudinal runner mounted to the frame for at least partially supporting the conveyor belt.

Furthermore, the conveyor may comprise upper conveyor belt guides mounted to interior faces of the upper side guards for positioning the conveyor belt between the upper conveyor belt guides and the longitudinal runners.

The frame may include opposed first and second rigid lower side guards. Each lower side guard may extend downwardly from one of the side frames below the conveyor belt so as to define a longitudinal bottom opening extending between the lower side guards. Furthermore, the conveyor may comprise a lower belt guard for at least partially covering the longitudinal bottom opening, and a lower belt guard guide located adjacent to the longitudinal bottom opening. The lower belt guard guide is shaped to provide a guideway for slidably receiving the lower belt guard.

The lower side guards may be removably mounted to the side frames. For, example, each side frame may include a plurality of downwardly extending pins, and each lower side guard may include a base portion with key slots shaped to receive the pins so as to removably mount the lower side guards to the side frames.

The conveyor may further comprise lower conveyor belt guides mounted to interior faces of the lower side guards for at least partially supporting the conveyor belt.

The conveyor may comprise at least one longitudinal runner removably mounted to the frame for at least partially supporting the conveyor belt. Furthermore, the frame may include a plurality of cross-members spaced apart longitudinally along the frame. Each cross-member may have a notch therein shaped to interlock with a corresponding notch on the longitudinal runner so as to removably mount the longitudinal runner to the frame.

The conveyor may comprise two side-by-side conveyor belts, and a longitudinally extending divider for separating the conveyor belts. The divider may be removably mounted to the frame.

According to another aspect of the present invention there is provided a conveyor comprising at least one endless conveyor belt extending longitudinally for conveying objects from an inlet end to an outlet end, and a frame extending longitudinally along the conveyor belt and having a cross-section that partially encloses the conveyor belt. The frame has at least one longitudinal opening extending longitudinally along the frame for providing access to the conveyor belt. The conveyor further comprises at least one removable belt guard for at least partially covering the longitudinal opening, and at least one belt guard guide located adjacent to the longitudinal opening. The belt guard guide is shaped to provide a guideway for slidably receiving the belt guard.

The frame may include opposed first and second side frames, and the at least one longitudinal opening may include first and second longitudinal side openings in the first and second side frames respectively.

The frame may include opposed first and second side frames, and opposed first and second rigid upper side guards. Each upper side guard may extend upwardly from one of the side frames above the conveyor belt. Furthermore, the at least one longitudinal opening may include a longitudinal top opening between the upper side guards.

The frame may include opposed first and second side frames, and opposed first and second rigid lower side guards. Each lower side guard may extend downwardly from one of the side frames below the conveyor belt. Furthermore, the at least one longitudinal opening may include a longitudinal bottom opening between the lower side guards.

Other aspects and features of the invention will become apparent, to those ordinarily skilled in the art, upon review of the following description of some exemplary embodiments.

### BRIEF DESCRIPTION OF THE DRAWINGS

The invention will now be described, by way of example only, with reference to the following drawings, in which:

FIG. 1 is a perspective view of a dual lane conveyor according to an embodiment of the invention;

FIG. 2 is a cross-sectional view of the conveyor of FIG. 1 along the line 2-2;

FIG. 3 is a close-up perspective view of the conveyor of FIG. 1;

FIG. 4 is a close-up perspective view of the conveyor of FIG. 1;

FIG. 5 is a close-up perspective view of the conveyor of FIG. 1 with an upper side guard removed and three longitudinal runners removed;

FIG. 6 is a perspective view of a single lane conveyor according to another embodiment of the invention; and

FIG. 7 is a cross-sectional view of the conveyor of FIG. 6 along the line 7-7.

### DETAILED DESCRIPTION OF THE INVENTION

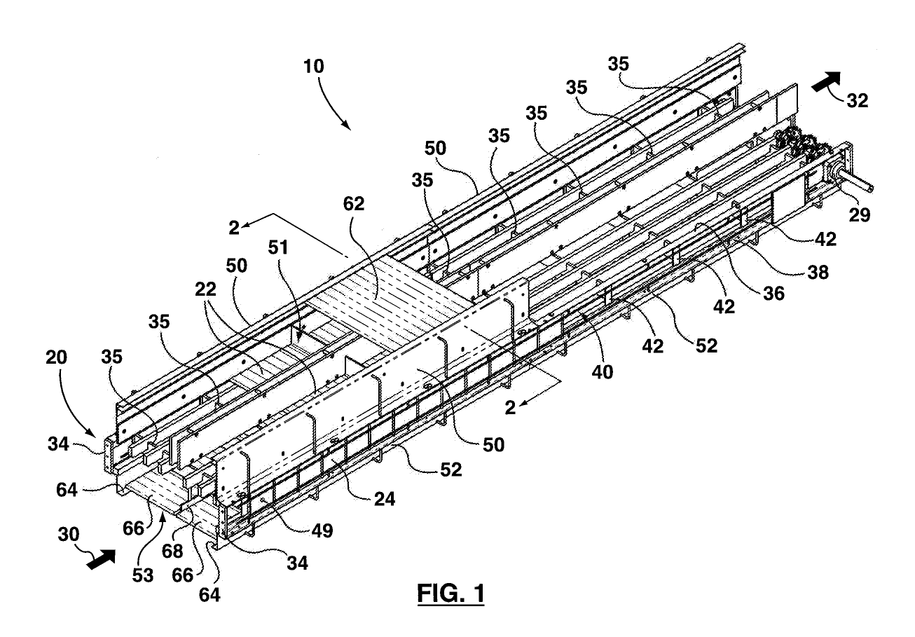

Referring to FIGS. 1-3, illustrated therein is a dual lane conveyor 10 made in accordance with an embodiment of the invention. The conveyor 10 comprises a frame 20 and two side-by-side endless conveyor belts 22 for conveying food products or other objects along the frame 20. The endless conveyor belts 22 extend longitudinally along the length of the frame 20. However, some longitudinal sections of the conveyor belts 22 have been removed in FIGS. 1-3 to show other portions of the conveyor.

The frame 20 extends longitudinally along the conveyor belts 22 between an inlet end (identified by arrow 30) and an outlet end (identified by arrow 32). The frame 20 includes two opposed side frames 34, and cross members 35 spaced apart intermittently along the length of the frame 20 so as to interconnect the opposed side frames 34.

The conveyor belts 22 generally convey food products or other objects from the inlet end 30 of the frame to the outlet end 32. More particularly, the conveyor belts 22 carry food products from the inlet end 30 to the outlet end 32 while moving along an upper portion of the frame 20. Once at the outlet end 32, the food products are transferred to another station, such as another conveyor, a loading dock, and so on. The conveyor belts 22 then cycle around the outlet end 32 and travel back toward the inlet end 30 along a bottom portion of the frame 20. The conveyor belts 22 are driven by a drive 29 (shown in FIG. 1), such as an electric or hydraulic motor (not shown) that turns an axle and gears that engage the conveyor belts 22.

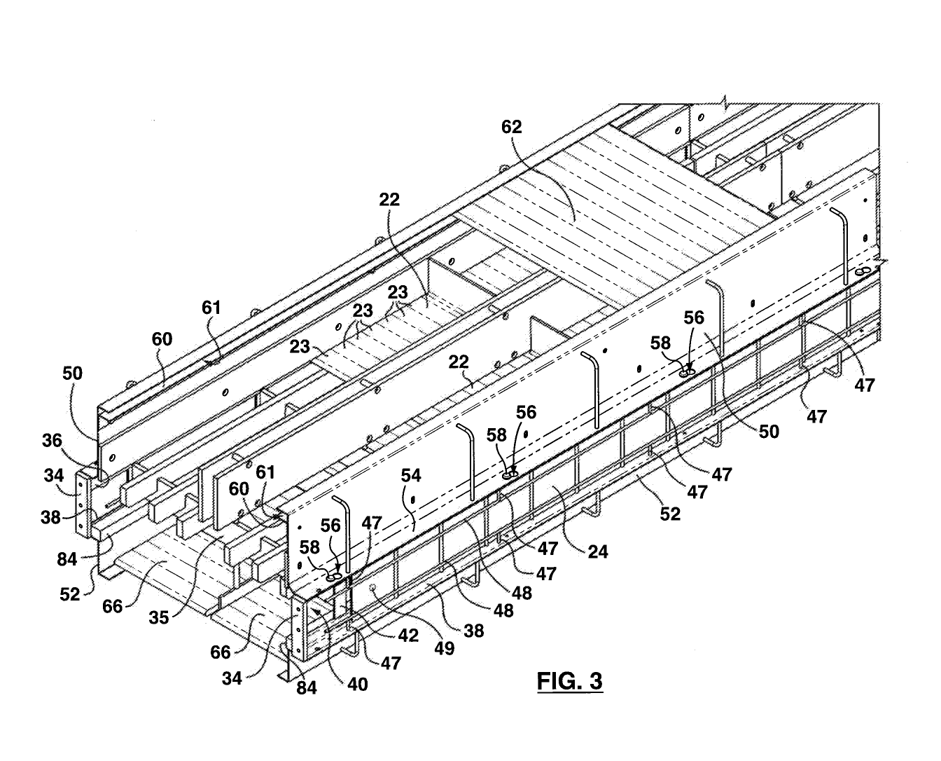

As shown in FIG. 3, the conveyor belts 22 are generally made of a plurality of thin rigid rectangular slabs 23 that are hinged together using plastic pins. Hinging the slabs 23 together allows the conveyor belt 22 to rotate around the ends 30 and 32 of the conveyor 10. The slabs 23 are made from UHMW polyethylene. In other embodiments, the conveyor belts 22 may have other configurations and may be made from different materials. For example, the conveyor belts 22 may be made from a continuous sheet of rubber.

The frame 20 has a cross-section that partially encloses the conveyor belts 22 (e.g. the opposed side frames 34 partially enclose the sides of the conveyor belts 22). The frame 20 also has a plurality of longitudinal openings extending longitudinally along the frame 20 that provide access to the conveyor belts 22. In particular, the frame 20 has two longitudinal side openings 40, a longitudinal top opening 51, and a longitudinal bottom opening 53.

The conveyor 10 further comprises a plurality of removable belt guards for covering the longitudinal openings. For example, the belt guards may include two side belt guards 24 for covering the longitudinal side openings 40 (only a portion of the right hand side belt guard is shown), an upper belt guard 62 for covering the longitudinal top opening 51 (only a portion of the upper belt guard is shown), and two lower belt guards 64 for covering the longitudinal bottom opening 53.

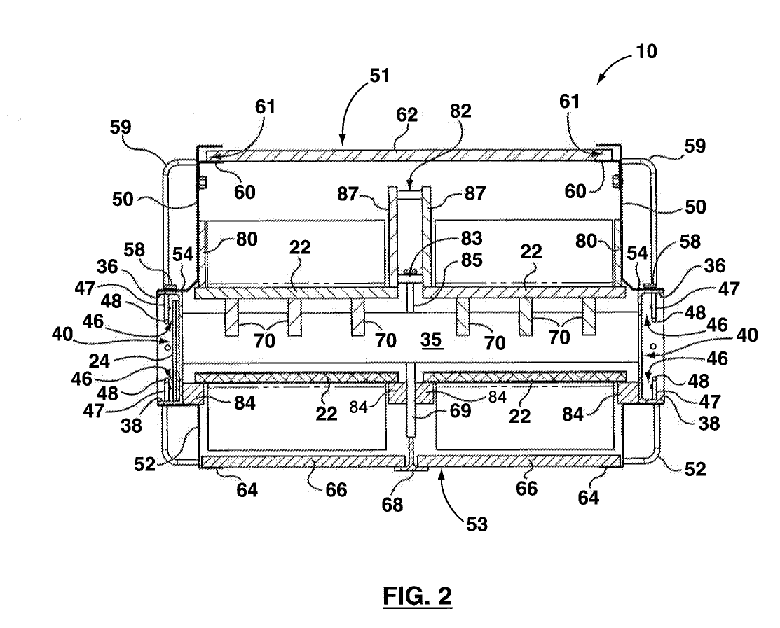

Referring to FIGS. 2 and 3, each side frame 34 has an upper member 36 and a lower member 38 spaced apart so as to define each of the longitudinal side openings 40 therebetween. The upper member 36 and the lower member 38 may be made from angle bars, and may be interconnected by flat bars 42 (shown in FIG. 1) that are intermittently spaced apart along the length of the frame 20. The flat bars 42 may be attached to the upper and lower members 36 and 38, for example, using welds, rivets, bolts, and so on.

The conveyor 10 further comprises belt guard guides located adjacent to each longitudinal opening. The belt guard guides are shaped to provide a guideway for slidably receiving one of the belt guards so as to cover the respective longitudinal opening 40. The guideways may be in the form slots, channels, grooves, recesses, ledges, and so on. For example, each side frame 34 has a belt guard guide in the form of two opposing longitudinal channels 46 (shown in FIG. 2) for slidably receiving the belts guards 24 so as to cover the longitudinal side openings 40.

In the illustrated embodiment, each side belt guard guide comprises upper and lower rails 48 extending longitudinally along the frame 20. The rails 48 are spaced laterally outwardly from the vertical portions of the upper and lower members 36 and 38 so as to define the channel 46 therebetween. Furthermore, the upper rail 48 is spaced downwardly from the horizontal portion of the upper member 36, and the lower rail 48 is spaced upwardly from the horizontal portion of the lower member 38. As shown, each rail 48 may be formed from a longitudinal rod connected to the horizontal portion of the upper and lower members 36 and 38 using vertical rods 47 spaced intermittently along the frame 20.

The conveyor belts 22 are generally disposed between the longitudinal side openings 40 on the side frames 34 such that the belt guards 24 at least partially cover the side openings 40 and thereby restrict access to the conveyor belts 22. For example, referring to FIGS. 1 and 3, the front right portion of the conveyor 10 has a belt guard 24 that partially covers a portion of the longitudinal opening 40. In some embodiments, two or more belt guards may be inserted into a single longitudinal opening 40 so as to cover the entire length of the side opening 40. In other embodiments, a single belt guard may cover the entire length of the side opening 40.

When the belt guards 24 are in place, they tend to prevent workers from placing their hands near the moving conveyor belts 22. The guards 24 may also help contain food products or scraps travelling on the conveyor belts 22.

When the belt guards 24 are removed from the frame 20, the longitudinal openings 40 provide access points for cleaning the conveyor belts 22. For example, referring to FIG. 2, there is no belt guard 24 on the right side of the conveyor 10 (which corresponds to the left side in FIGS. 1 and 3) and the longitudinal opening 40 provides an access point for spraying the conveyor belt 22 with a cleaning solution.

The belt guards 24 are configured to slide into the guideways defined by the opposing longitudinal channels 46 along the side frames 34. Furthermore, the belt guards 24 are generally flexible and can be rolled up once they are removed from the channels 46. In the illustrated embodiment, the belt guards 24 are made from thermoplastic polyurethane. In other embodiments, the belt guards 24 may be made from other materials such as ultra high molecular weight polyethylene (UHMW), rubber, and so on.

In the illustrated embodiment, the belt guards have a thickness of about ⅛ of an inch, which may provide flexibility as described above. Furthermore, the belt guards 24 have transverse ribs that are spaced apart at approximately 2-inch intervals and have a thickness of about ⅜-inch. The ribs tend to increase the rigidity of the belt guards 24 in the transverse direction, while still providing flexibility in the longitudinal direction such that the belt guards 24 can be rolled up after being removed. Furthermore, the rails 48 on the side frames 34 of the frame 20 tend to stiffen the flexible belt guards 24 and help retain the belt guards 24 in place.

The conveyor 10 also includes removable fasteners 49 for removably securing the belt guards 24 to the frame 20, such as bolts, screws, locking pins, and so on. For example, the fastener 49 may be a bolt that is inserted through an aperture in the belt guard 24 and threaded into a corresponding threaded aperture in one of the flat bars 42 along the side frame 34. The fasteners 49 are often required by legislation and regulations for safety reasons. In particular, it is understood that some legislation and regulations require that the guards be affixed to the conveyor such that a tool is needed to remove the guard. This tends to prevent workers from removing the belt guards, which might otherwise pose a safety risk.

When it is time to clean the conveyor 10, the drive 29 is turned off and the fasteners 49 are removed such that a worker can slide the guards 24 out of the longitudinal channels 46. The remaining portions of the conveyor 10 can then be cleaned, for example, by spraying a cleaning solution through the longitudinal openings 40 using a pressure washer.

Referring now to FIGS. 1, 3 and 4, the frame 20 also includes opposed rigid upper side guards 50 and opposed rigid lower side guards 52 that are removably mounted to the side frames 34. The side guards 50 and 52 are generally made of a metal such as 14-gauge stainless steel, or other suitable materials such as plastic, and so on.

As shown in FIG. 1, two upper side guards 50 are mounted end-to-end to each side frame 34 (the rear right upper side guard 50 is removed in FIG. 1), and two lower side guards 52 mounted end-to-end to each side frame 34. Mounting two or more side guards 50 and 52 end-to-end on each side frame 34 reduces the weight of each individual side guard, which tends to make mounting and dismounting the side guards easier.

Referring to FIGS. 2 and 3, the upper side guards 50 are mounted to the upper member 36 of the side frames 34 and extend upwardly from the side frame 34 above the conveyor belt 22. In particular, the upper side guards 50 have a base 54 with key slots 56 formed therein that are shaped to engage pins 58 that extend upward from the upper members 36 of the side frames 34. The key slots 56 in the upper side guards 50 have two side-by-side apertures. One aperture is sized larger than the head of the pin 58, and the other aperture is sized smaller than the head of the pin 58. Accordingly, when mounting the upper side guards 50 to the side frames 34, the larger aperture receives the pin 58 therethrough, and then the upper side guard 50 slides forward to position the head of the pin 58 over the smaller aperture such that the head of the pin 58 engages the base 54 and holds the upper side guard 50 in place. The upper side guards 50 may include one or more handles 59 to help mount and dismount the upper side guards 50.

Similarly, the lower side guards 52 are mounted to a lower portion of the side frames 34 and extend downwardly from the side frames 34 below the conveyor belt. The lower side guards 52 may be mounted to the side frames 34 in a similar way as the upper side guards 50 (e.g. using pins, keyslots, and handles).

Both the upper and lower side guards 50 and 52 may be removably secured to the side frames 34 using fasteners such as bolts, which may be required to comply with local legislation and/or regulations.

While the side guards of the illustrated embodiment are removable, in some embodiments, the upper and lower side guards may be permanently affixed to the side frames 34.

As shown, the upper side guards 50 are spaced apart so as to define a longitudinal top opening 51 therebetween. Similarly, the lower side guards 4250 are spaced apart so as to define a longitudinal bottom opening 51 therebetween. As shown in the illustrated embodiment, these openings 51, 53 may be covered by belt guards 62 and 66.

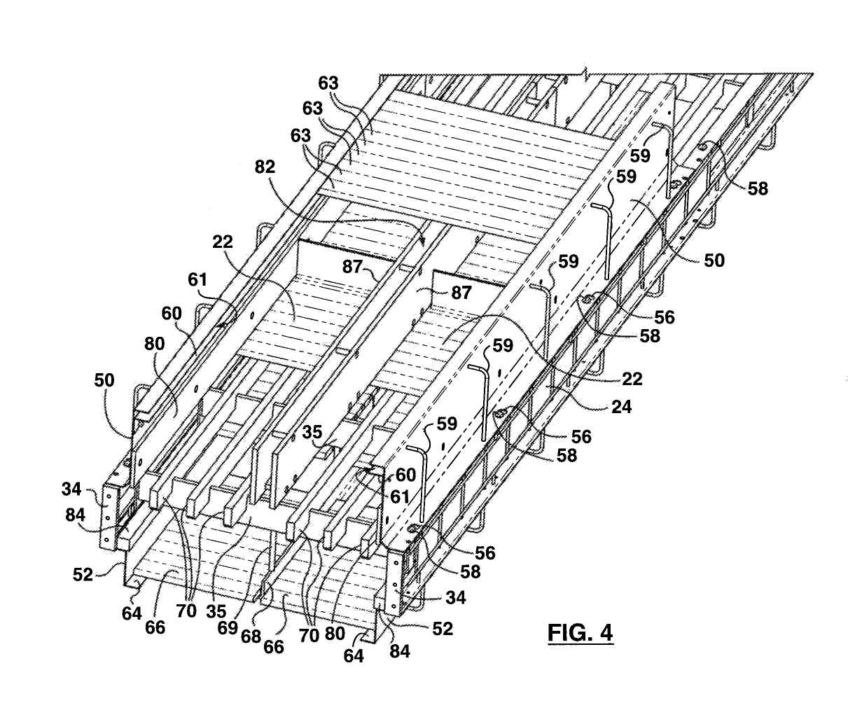

Referring again to FIGS. 2 and 4, the conveyor 10 includes an upper belt guide shaped to provide a guideway for slidably receiving an upper belt guard 62. In particular, the top portions of the upper side guards 50 bend inward toward each other and have opposing spaced apart flanges 60 attached thereto. The bent portions and the flanges 60 define opposed longitudinal slots 61 adjacent to the longitudinal top opening 51, which provide a guideway for slidably receiving the upper belt guard 62 so as to at least partially cover the longitudinal top opening 51 and restrict access to the conveyor belt 22.

The upper belt guard 62 is generally similar to the belt guards 24 described previously and may be attached to the frame 20 using a fastener (not shown). One difference is that the upper belt guard 62 is made in a similar fashion as the conveyor belt 22. In particular, the upper belt guard 62 includes a plurality of thin rigid rectangular slabs 63 that are hinged together using plastic pins. The slabs 63 are made from UHMW polyethylene. Accordingly, the upper belt guard 62 is stiffer than the belt guards 24 described previously, yet the hinged construction enables the upper belt guard 62 to be rolled up for easy removal and storage.

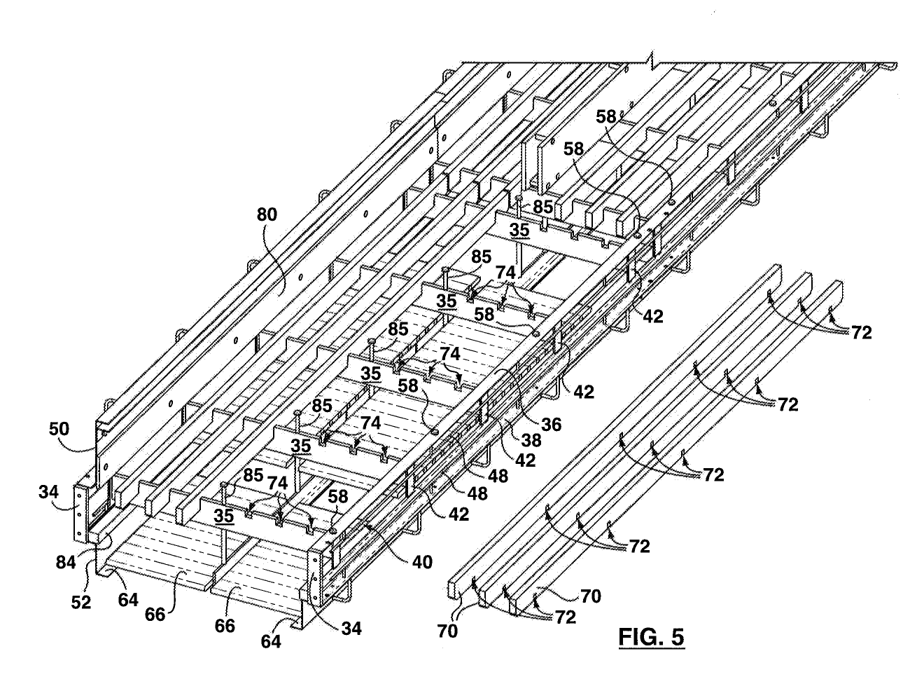

The conveyor 10 further includes two lower belt guides shaped to provide guideways for slidably receiving the lower belt guards 62. In particular, the bottom portions of the lower side guards 52 bend inward toward each other and form ledges 64. The ledges 64 are generally configured to partially support the lower belt guards 66. The conveyor 10 also includes a central support member 68 located between the ledges 64. The Support member 68 also includes ledges for supporting the lower belt guards 66. The support member 68 is coupled to the frame 20 using rods 69 that extend downward from the cross members 35 (e.g. see FIG. 5). In some embodiments, the support member 68 may be omitted, and there may be a single lower belt guard received by the ledges 64.

The lower belt guards 66 are generally similar to the upper belt guards 62 described previously and may be attached to the frame 20 using fasteners (not shown).

Referring now to FIGS. 2, 4, and 5, the conveyor 10 includes removable longitudinal runners 70 extending along the frame 20 for supporting the conveyor belts 22. As shown in FIG. 5, the runners 70 have notches 72 on their bottom surface that interlock with corresponding notches 74 on the top surface of cross-members 35 of the frame 20 so as to secure the runners 70 in place during use. When it is time to clean the conveyor 10, the conveyor belts 22 are removed, and then the runners 70 are removed by pulling them upward from the cross-members 72. This tends to allow thorough cleaning of the runners 70 and the frame 20.

Referring again to FIGS. 2 and 4, the conveyor 10 includes upper belt guides 80 attached to the inner surfaces of the upper side guards 50, for example using a fastener such as a bolt. The upper belt guides 80 position and align the edges of the conveyor belt 22. In particular, the upper belt guides 80 positions the upper portion of the conveyor belt 22 between upper belt guides 80 and the runners 70 while travelling from the inlet end 30 to the outlet end 32. The upper belt guides 80 may also help contain food products travelling on the conveyor belt 22. The upper belt guides 80 may be made from a plastic such as UHMW polyethylene, or another suitable material.

Similarly, the conveyor 10 includes lower belt guides 84 attached to the lower side guards 52. The lower belt guides 84 may support and align the edges of the conveyor belt 22. In particular, the lower belt guides 84 support the edges of the lower portion of the conveyor belts 22 while returning from the outlet end 32 back to the inlet end 30. The lower belt guides 84 may be made from a plastic such as UHMW polyethylene, or another suitable material.

In the illustrated embodiment, the two side-by-side conveyor belts 22 are separated by a divider 82. Similar to the rigid upper side guards 50, the divider 82 is removably mounted to the frame 20. For example, the divider 82 may have a base member 83 (shown in FIG. 2) with key slots therein (not shown) that are shaped to engage pins 85 (shown in FIG. 5) extending upward from the cross members 35.

The divider 82 may also be used to support and align the conveyor belt 22 in a similar fashion to the upper belt guides 80. Accordingly, the divider 82 may include upper belt guides 87 (e.g. side panels) for positioning the conveyor belts 22 between the upper belt guides 87 and the longitudinal runners 70. The upper belt guides 87 may be made from a plastic such as UHMW polyethylene or another suitable material.

In use, the conveyor 10 can be disassembled and cleaned in two stages. The first stage is used for daily cleaning, and the second stage is used for more rigorous monthly cleaning. In the first stage, the belts guards 24, 62, and 66 on the lateral, top, and bottom sides of the conveyor 10 are removed. The first stage also includes removing the upper and lower side guards 50 and 52 and the divider 82. A cleaning solution can be sprayed onto the remaining portions of the conveyor 10 to remove contaminants.

In some embodiments, some parts of the conveyor 10 may remain attached to the frame 20 while cleaning the conveyor 10 in the first stage. For example, the upper and lower side guards 50 and 52, and the divider 82 may remain attached to the frame 20. This may be desirable when performing a quicker clean.

The second stage continues beyond the first stage and includes removing the conveyor belts 22 and the runners 70. The only parts of the conveyor 10 remaining are the side frames 34, the cross-members 35, the rails 48, pins 58, 85, and other components for driving the conveyor belt (e.g. drive rollers, bearings, shafts, etc). This enables thorough cleaning of the frame 20, for example, using a pressure washer. The other parts of the conveyor 10 that have been removed may be cleaned separately.

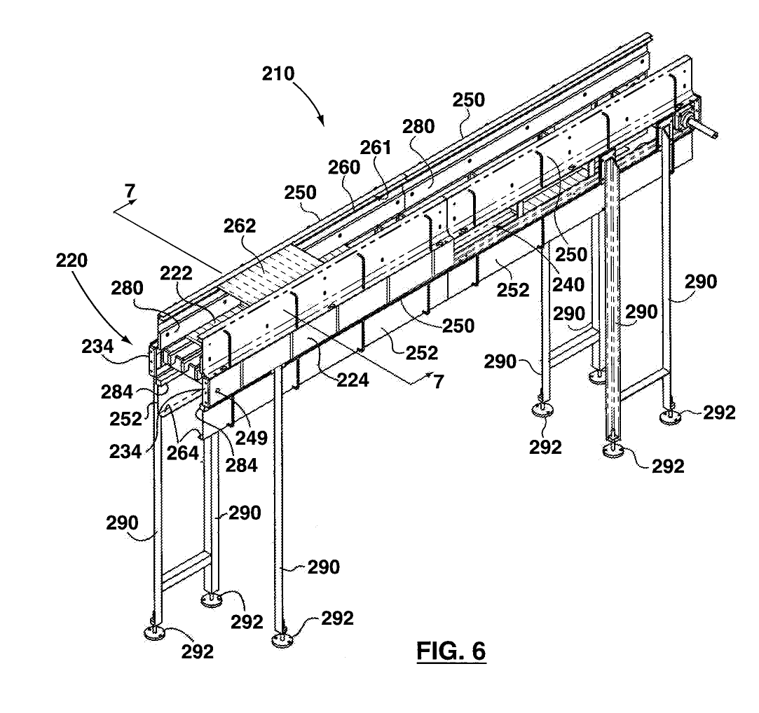

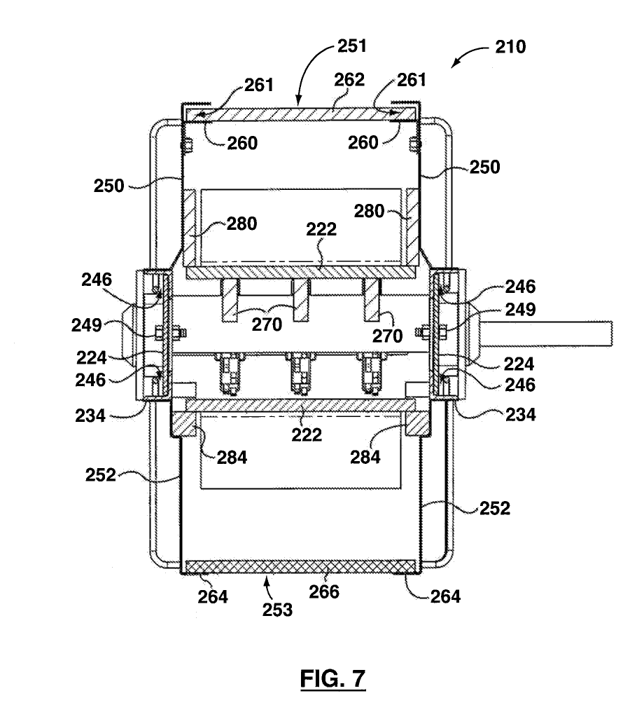

Referring now to FIGS. 6 and 7, illustrated therein is a single lane conveyor 210 made in accordance with another embodiment of the invention. The conveyor 210 is generally similar to the conveyor 10 and similar elements are given similar reference numerals incremented by two hundred.

The conveyor 210 comprises a frame 220, an endless conveyor belt 222 for conveying food products or other objects along the frame 220, and removable belt guards 224 securable to the frame 220 so as to at least partially restrict access to the conveyor belt 222. More particularly, the frame 220 includes side frames 234 having longitudinal side openings 240, and longitudinal channels 246 for slidably receiving side belt guards 224. The belt guards 224 may be removably secured to the frame 220 using one or more removable fasteners 249 such as bolts, screws, locking pins, and so on.

The conveyor 210 also includes upper and lower rigid side guards 250 and 252 that are removably mounted to the side frames 234. A top longitudinal opening 251 is located between the upper side guards 250. Further, the upper side guards 250 define an upper belt guide in the form of bent portions and flanges 260 that define opposing longitudinal slots 261 (e.g. a guideway) for receiving an upper belt guard 262.

Similarly, a bottom longitudinal opening 253 is located between the lower side guards 252. Furthermore, the lower side guards define a lower belt guide in the form of ledges 264 that provide a guideway for receiving and supporting a lower belt guard 266.

The conveyor 210 also includes removable longitudinal runners 270 extending along the frame 220 for supporting the conveyor belts 222.

The conveyor 210 includes upper belt guides 280 attached to the inner surfaces of the upper side guards 250. Similarly, the conveyor 210 also includes lower belt guides 284 attached to the lower side guards 252. The upper and lower belt guides 280 and 284 may help support, position and align the conveyor belt 222 as it moves along the frame 220.

One difference between the conveyor 210 and the conveyor 10 described previously is that the conveyor 210 does not include a divider 82 because it is a single lane conveyor having only one conveyor belt 222. In some embodiments, the conveyor 210 may include one or more dividers that divide the conveyor belt 222 into two or more lanes.

Another difference is that the conveyor 210 includes risers 290 that support the frame 220 above a support surface. As shown, the risers 290 are attached to the side frames 234 and extend downward toward the support surface. The risers 290 may have extendable feet 292 for adjusting the height of the frame, for example, to level the frame 220 on the support surface.

While the above description provides examples of one or more apparatus, systems and methods, it will be appreciated that other apparatus, systems and methods may be within the scope of the present description as interpreted by one of skill in the art.

1. A conveyor comprising:
(a) at least one endless conveyor belt extending longitudinally for conveying objects from an inlet end to an outlet end;
(b) a frame extending longitudinally along the conveyor belt and having a cross-section that partially encloses the conveyor belt, wherein the frame includes opposed first and second side frames, each side frame having a longitudinal side opening extending longitudinally along the side frame for providing access to the conveyor belt;
(c) first and second removable belt guards, each belt guard being configured to at least partially cover one of the longitudinal side openings; and
(d) first and second belt guard guides, each belt guard guide being located adjacent to one of the longitudinal side openings and being shaped to provide a guideway for slidably receiving one of the belt guards.

2. The conveyor of claim 1, further comprising fasteners for removably securing the belt guards to the frame.

3. The conveyor of claim 1, wherein each side frame includes opposed upper and lower members spaced apart so as to define the longitudinal side opening therebetween, and wherein each belt guard guide comprises:
(a) a longitudinally extending upper rail spaced laterally outwardly and downwardly from the upper member; and
(b) a longitudinally extending lower rail spaced laterally outwardly and upwardly from the lower member.

4. The conveyor of claim 1, wherein the frame includes opposed first and second rigid upper side guards, each upper side guard extending upwardly from one of the side frames above the conveyor belt so as to define a longitudinal top opening extending between the upper side guards, and wherein the conveyor further comprises:
(a) an upper belt guard for at least partially covering the longitudinal top opening; and
(b) an upper belt guard guide located adjacent to the longitudinal top opening, the upper belt guard guide being shaped to provide a guideway for slidably receiving the upper belt guard.

5. The conveyor of claim 4, wherein the upper side guards are removably mounted to the side frames.

6. The conveyor of claim 5, wherein each side frame includes a plurality of upwardly extending pins, and wherein each upper side guard includes a base portion with key slots shaped to receive the pins so as to removably mount the upper side guard to the side frame.

7. The conveyor of claim 4, further comprising at least one longitudinal runner mounted to the frame for at least partially supporting the conveyor belt.

8. The conveyor of claim 7, further comprising upper conveyor belt guides mounted to interior faces of the upper side guards for positioning the conveyor belt between the upper conveyor belt guides and the longitudinal runners.

9. The conveyor of claim 1, wherein the frame includes opposed first and second rigid lower side guards, each lower side guard extending downwardly from one of the side frames below the conveyor belt so as to define a longitudinal bottom opening extending between the lower side guards, and wherein the conveyor further comprises:
(a) a lower belt guard for at least partially covering the longitudinal bottom opening; and
(b) a lower belt guard guide located adjacent to the longitudinal bottom opening, the lower belt guard guide being shaped to provide a guideway for slidably receiving the lower belt guard.

10. The conveyor of claim 9, wherein the lower side guards are removably mounted to the side frames.

11. The conveyor of claim 10, wherein each side frame includes a plurality of downwardly extending pins, and wherein each lower side guard includes a base portion with key slots shaped to receive the pins so as to removably mount the lower side guards to the side frames.

12. The conveyor of claim 9, further comprising lower conveyor belt guides mounted to interior faces of the lower side guards for at least partially supporting the conveyor belt.

13. The conveyor of claim 1, further comprising at least one longitudinal runner removably mounted to the frame for at least partially supporting the conveyor belt.

14. The conveyor of claim 13, wherein the frame includes a plurality of cross-members spaced apart longitudinally along the frame, each cross-member having a notch therein shaped to interlock with a corresponding notch on the longitudinal runner so as to removably mount the longitudinal runner to the frame.

15. The conveyor of claim 1, wherein the at least one conveyor belt includes two side-by-side conveyor belts, and wherein the conveyor further comprises a longitudinally extending divider for separating the conveyor belts.

16. The conveyor of claim 15, wherein the divider is removably mounted to the frame.

17. A conveyor comprising:
(a) at least one endless conveyor belt extending longitudinally for conveying objects from an inlet end to an outlet end;
(b) a frame extending longitudinally along the conveyor belt and having a cross-section that partially encloses the conveyor belt, wherein the frame has at least one longitudinal opening extending longitudinally along the frame for providing access to the conveyor belt;
(c) at least one removable belt guard for at least partially covering the longitudinal opening;
(d) at least one belt guard guide located adjacent to the longitudinal opening, the belt guard guide being shaped to provide a guideway for slidably receiving the belt guard.

18. The conveyor of claim 17, wherein the frame includes opposed first and second side frames, and wherein the at least one longitudinal opening includes first and second longitudinal side openings in the first and second side frames respectively.

19. The conveyor of claim 17, wherein the frame includes:
(a) opposed first and second side frames; and
(b) opposed first and second rigid upper side guards, each upper side guard extending upwardly from one of the side frames above the conveyor belt, and wherein the at least one longitudinal opening includes a longitudinal top opening between the upper side guards.

20. The conveyor of claim 17, Wherein the frame includes:
(a) opposed first and second side frames; and
(b) opposed first and second rigid lower side guards, each lower side guard extending downwardly from one of the side frames below the conveyor belt, and wherein the at least one longitudinal opening includes a longitudinal bottom opening between the lower side guards.
